(19) United States
(12) Patent Application Publication
(10) Pub. No.: US 2013/0311838 A1
(43) Pub. Date: Nov. 21, 2013

(54) INFORMATION PROCESSING APPARATUS, INFORMATION PROCESSING SYSTEM AND DATA FORWARDING METHOD

(71) Applicant: FUJITSU LIMITED, Kawasaki-shi (JP)

(72) Inventor: Masayuki SHIMIZU, Inagi (JP)

(73) Assignee: Fujitsu Limited, Kawasaki-shi (JP)

(21) Appl. No.: 13/952,758

(22) Filed: Jul. 29, 2013

Related U.S. Application Data
(63) Continuation of application No. PCT/JP2011/052791, filed on Feb. 9, 2011.

(51) Int. Cl. G06F 11/08

(52) U.S. Cl. CPC G06F 11/08
USPC 714/49

(57) ABSTRACT

An information processing apparatus connected to an inputting/outputting apparatus includes a storage apparatus configured to store data, a calculation processing apparatus configured to issue an order, and a data forwarding apparatus configured to generate, upon receiving a data forwarding order issued by the calculation processing apparatus, based on data stored by the storage apparatus, first error inspection data to detect an error of the data, forward the data and the first error inspection data to the inputting/outputting apparatus, generate, upon receiving an data inspection order issued by the calculating processing apparatus, based on data stored by the storage apparatus, second error inspection data to detect an error of the data, and report occurrence of an error to the calculation processing apparatus, when a result of comparison of the first error inspection data generated by another data forwarding apparatus and the second error inspection detail is a mismatch.

### CROSS-REFERENCE TO RELATED APPLICATIONS

This application is a continuation application of International Application PCT/JP2011/052791 filed on Feb. 9, 2011, and designated the U.S., the entire contents of which are incorporated herein by reference.

### FIELD

The embodiments discussed herein are related to an information processing apparatus, an information processing system and a data forwarding method.

### BACKGROUND

An information processing apparatus such as a computer stores necessary data in a main storage apparatus and performs processing. Data stored in the main storage apparatus of the information processing apparatus is forwarded from an external storage apparatus connected to the information processing apparatus, a media drive apparatus that accesses a recording medium such as an optical disc, or an Input Output apparatus (hereinafter, an “IO apparatus”) connected to another information processing apparatus connected via a transmission path. To perform this data forwarding, one or more data forwarding apparatuses are mounted on the information processing apparatus. An information processing system in a configuration including an information processing apparatus and an IO apparatus to perform data input/output with the information processing apparatus performs data forwarding between the main storage apparatus and the IO apparatus using the data forwarding apparatus provided in the information processing apparatus.

FIG. 1 is a diagram illustrating data forwarding performed in a conventional information processing system.

The information processing apparatus 1 being a computer and the like includes a CPU (Central Processing Unit) 11, a memory 12 being a main storage apparatus, a plurality of channel apparatuses 13 being a data forwarding apparatus, and an IO processor (IOP: Input Output Processor) that controls the operation of each channel apparatus 13. In the example presented in FIG. 1, each channel apparatus 13 performs data forwarding between the memory 12 and the IO apparatus 2 that is connected to the information processing apparatus 1.

When performing data forwarding, each channel apparatus 13 performs reception/transmission of data, and CRC (Cyclic Redundancy Check) data. The CRC data is data generated using the transmitted/received data. The content of the CRC data changes depending on the content of the data used for the generation. Based on this, the CRC data is added to the transmitted/received data so as to make it possible to check the error of the transmitted/received data, that is, whether or not the transmitted/received data is correct.

The receiving side in the channel apparatus 13 and the IO apparatus 2 that receives data and CRC data generates the CRC data using the received data, and compares the generated CRC data with the received CRC data. By this comparison, the receiving side determines that there is an error in the received data, when the generated CRC data and the received CRC data do not match. As described above, appropriate data transmission/reception is realized between the channel apparatus 13 and the IO apparatus 2 using CRC data. Accordingly, data forwarded between the channel apparatus 13 and the IO apparatus 2 is a subject of protection by CRC data.

An original data area 12a on the memory 12 is an area that stores data to be the subject of forwarding on the memory 12, or an area that stores forwarded data. The original data area 12a is specified by the start address that indicates the start of the original data area 12a, and the data length (for example, the byte count). The CPU 11 performs a forwarding instruction to the channel apparatus 13 via the IOP 14 for example specifying the start address and the data length, to make it access the original data area 12a.

For example, there is a possibility that a failure occurs in the channel apparatus 13 that data forwarding between the channel apparatus 13 and the IO apparatus 2 may be performed appropriately but it is impossible to access the original data area 12a of the memory 12. When a failure that it is impossible to access the original data area 12a of the memory 12 occurs, even when errors are monitored using CRC data about data forwarding between the channel apparatus 13 and the IO apparatus 2, it is impossible to detect the failure that the channel apparatus 13 is unable to access the data area 12a of the memory 12.

There is a case in which a virtual storage apparatus is mounted on an information processing apparatus. In an information processing apparatus on which a virtual storage apparatus is mounted, apart from the real address (physical address) used when accessing a physical storage apparatus, a logical address (virtual address) being an address used when accessing a virtual space is used. In an information processing apparatus on which a virtual storage apparatus is mounted, since two different addresses, the real address and the logical address are used, an address conversion function to convert the logical address into the real address is implemented in the channel apparatus. For example, the channel apparatus 13 in which the address conversion function has failed is unable to access the original data area 12a of the memory 12. Based on this, it maybe said that, in order to perform appropriate data forwarding with more certainty, there is a need to monitor data forwarding outside the range of data forwarding between the channel apparatus 13 and the 10 apparatus 2 that has been monitored conventionally.

Patent document 1: Japanese Laid-open Patent Publication No. 5-73444

Patent document 2: Japanese Laid-open Patent Publication No. 2009-282651

### SUMMARY

According to an aspect of the embodiments, an information processing apparatus connected to an inputting/outputting apparatus includes a storage apparatus configured to store data, a calculation processing apparatus configured to issue an order, and a data forwarding apparatus configured to generate, upon receiving a data forwarding order issued by the calculation processing apparatus, based on data stored by the storage apparatus, first error inspection data to detect an error of the data, forward the data and the first error inspection data to the inputting/outputting apparatus, generate, upon receiving an data inspection order issued by the calculating processing apparatus, based on data stored by the storage apparatus, second error inspection data to detect an error of the data, and report occurrence of an error to the calculation processing apparatus, when a result of comparison of the first error inspection data generated by another data forwarding apparatus and the second error inspection data is a mismatch.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating data forwarding performed in a conventional information processing system.

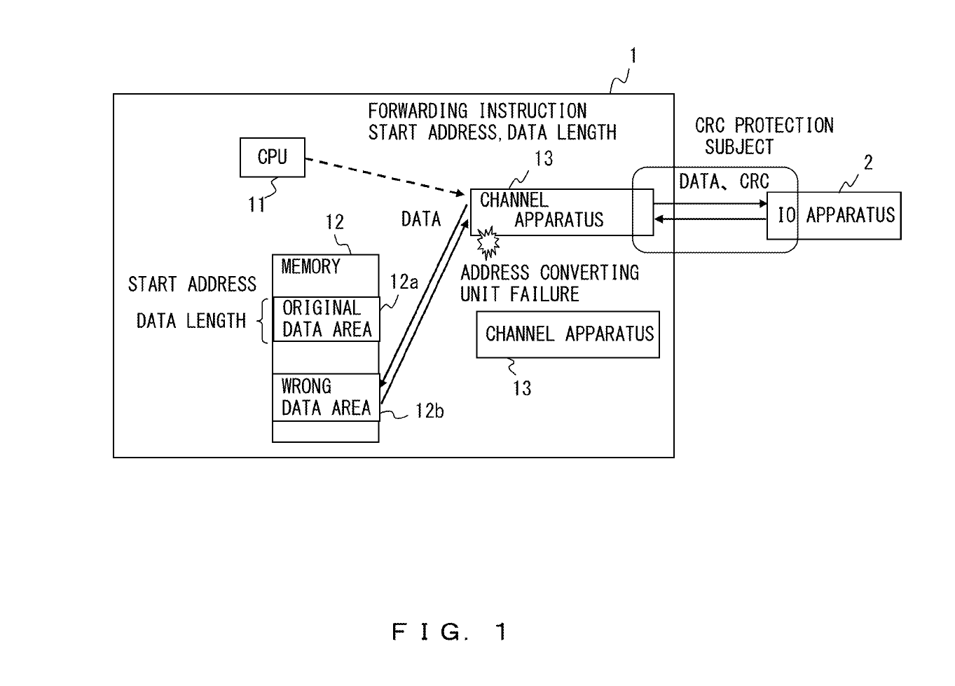

FIG. 2 is a diagram illustrating the configuration of an information processing system according to the present embodiment.

FIG. 3 is a diagram illustrating the data configuration of an SSCH order in the present embodiment.

FIG. 4 is a diagram illustrating the configuration of a channel apparatus according to the present embodiment.

FIG. 5 is a diagram illustrating the configuration, and the operation of an address converting unit.

FIG. 6A is a diagram illustrating data stored in an entry of a segment table.

FIG. 6B is a diagram illustrating data stored in an entry of a page table.

FIG. 7 is a diagram presenting a sequence in which data forwarding according to an SSCH order is performed.

FIG. 8 is a diagram illustrating information stored in a memory and a storage method for understanding the busy status of each channel apparatus.

FIG. 9 is a diagram illustrating the range in which data forwarding is monitored according to the present embodiment.

FIG. 10 is a flowchart of the first data forwarding process.

FIG. 11 is a flowchart of the second data forwarding process.

FIG. 12 is a flowchart of a CRC recalculation process.

FIG. 13 is a flowchart of the first half of an IO process.

FIG. 14 is a flowchart of the second half of an IO process.

FIG. 15 is a sequence diagram presenting the flow of the process that each channel apparatus and the CPU execute at the time of normal operation.

FIG. 16 is a sequence diagram presenting the flow of the process that each channel apparatus and the CPU execute at the time of occurrence of a failure.

### DESCRIPTION OF EMBODIMENTS

Hereinafter, embodiments of the present invention are described in detail with reference to the drawings.

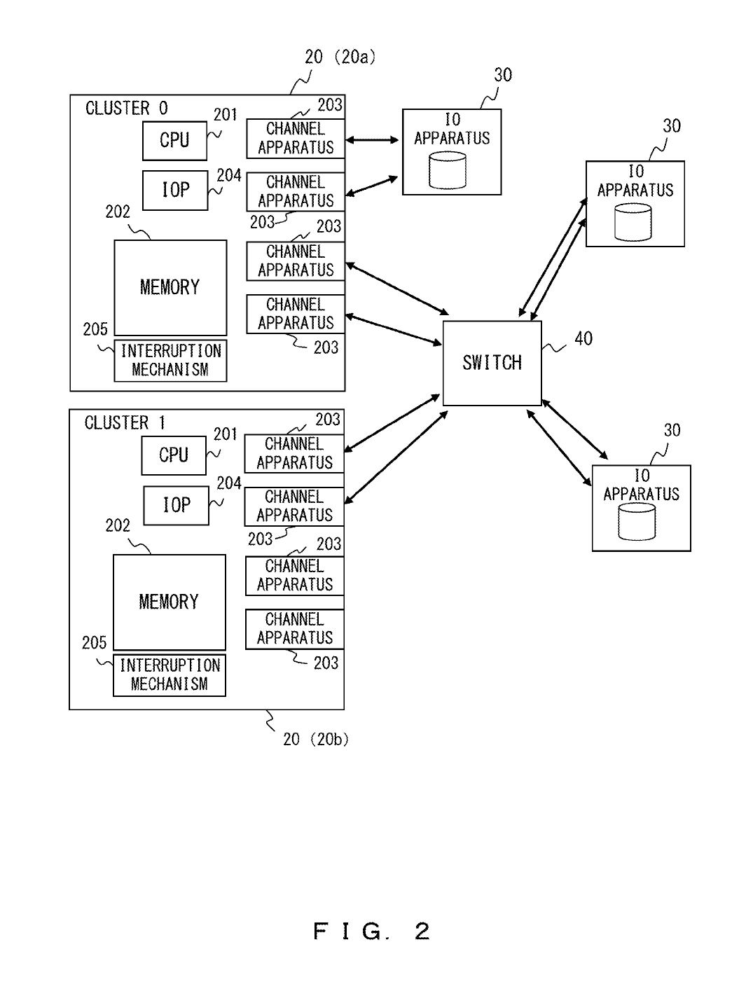

FIG. 2 is a diagram illustrating the configuration of an information processing system according to the present embodiment.

The configuration of the information processing system includes a plurality of clusters 20 each of which corresponds to a computer (information processing apparatus), a plurality of IO apparatuses 30 and a switch 40 that connects the cluster 20 and the IO apparatus 30. In FIG. 2, there is only one unit of the IO apparatus 30 directly connected to the cluster 20a of which cluster number is 0. In addition, while any IO apparatus 30 directly connected to the closer 20b of which cluster number is 1 is not illustrated in the diagram, there may exist the IO apparatus 30 connected directly to each cluster 20. The IO apparatus 30 is, for example, a hard disk apparatus, an optical disk apparatus, or a file apparatus such as a file server and the like that manages a plurality of types of storage apparatuses. The IO apparatus 30 may be an external apparatus connected via a network.

A virtual storage apparatus is mounted on each cluster 20. Each cluster 20 includes a CPU 201, a memory 202 being a main storage apparatus, a plurality of channel apparatuses 203 being a data forwarding apparatus, an IO processor (IOP) 204 that controls the operation of each channel apparatus, and an interruption mechanism 205. The completion of data forwarding performed by the channel apparatus 203 is reported to the CPU 201 via the interruption mechanism 205. While FIG. 2 illustrates four units of the channel apparatuses 203 included inside the cluster 20, more channel apparatuses 203 may be mounted on each cluster 20. The virtual storage apparatus is realized by, for example, the cooperation of hardware such as a memory management apparatus (for example, MMU: Memory Management Unit) mounted on the CPU 201 and an Operating System executed by the CPU 201.

When making the channel apparatus 203 perform data forwarding, the CPU 201 issues an SSCH (Start Sub Channel) order to the channel apparatus 203 via the IOP 204. In the present embodiment, a channel apparatus 203 that is different from the channel apparatus 203 that is made to execute the SSCH order is made to access data that has become the subject of data forwarding, and is made to generate identification information according to the content of the data. The generated identification information is compared with identification information generated by the channel apparatus 203 that actually performed data forwarding. Any identification information of which content changes depending on the content of data will do. In the current embodiment, as an example of identification information, CRC (Cyclic Redundancy Check) data is used.

When a program executed by the CPU 201 accesses the memory 202, the CPU 201 converts a logical address specified in the program into a real address on the memory 202, and checks whether or not a page including the converted real address exists on the memory 202. The issue of the SSCH order by the CPU 201 is performed when the nonexistence of a page including the converted real address on the memory 202 is confirmed, to obtain a page including the real address that does not exist on the memory 202 from the IO apparatus 30.

In each cluster 20, apart from the real address (physical address) used when accessing the memory 202 being a physical main storage apparatus, a logical address (virtual address) being an address used when accessing a virtual space is used. The logical address is used when accessing the IO apparatus 30. Each channel apparatus is equipped with an address conversion function to convert a logical address into a real address. The channel apparatus 203 in which a failure occurs in the address conversion function is unable to perform appropriate data forwarding with the memory 202. That is, there is a possibility that the channel apparatus 203 may be unable to appropriately perform access to the memory 202, more specifically, read-out of data from the memory 202, or write-in of data into the memory 202. However, when the channel apparatus that executed the SSCH order and another channel apparatus 203 provided in the same cluster as each other are able to appropriately perform access to the same data stored in the memory 202, since respective channel apparatuses access the same data stored in the memory 202, it follows that identification information (CRC data) generated by respective channel apparatuses 203 match. Accordingly, whether or not the channel apparatus 203 that actually performed data forwarding performed data forwarding with the memory 202 appropriately may be checked by comparing CRC data generated by respective channel apparatuses.

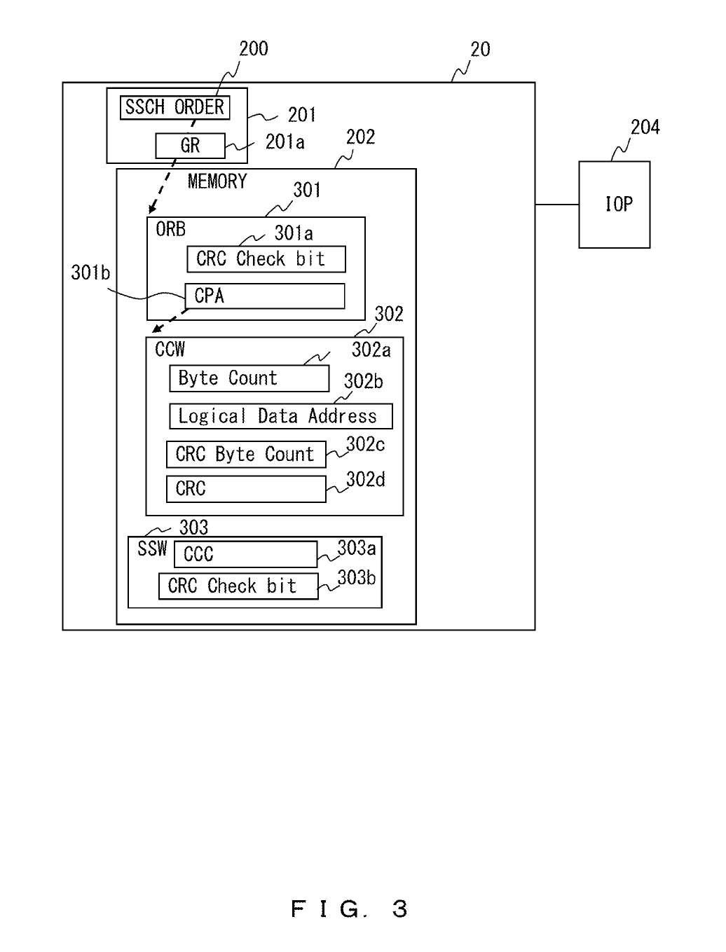

In this embodiment, a different channel apparatus 203 from the channel apparatus 203 that performed data forwarding is made to perform the comparison of CRC data. By making a different channel apparatus 203 from the channel apparatus that performed data forwarding perform the comparison of CRC data, the increase in the load of the CPU 201 generated to monitor data forwarding between the memory 202 and the channel apparatus 203 is suppressed. It is also one of the reasons to use a different channel apparatus 203 from the channel apparatus that performed data forwarding as available resource for the monitoring of data forwarding is that a number of channel apparatuses are commonly mounted on the information processing apparatus. When the load of the CPU 201 is relatively light, the CPU 201 may be made to perform the comparison of CRC data. In this case, the CRC data that the different channel apparatus 203 was made to generate may be made available for the CPU 201 to obtain, by storing it in a CCW (Channel Command Word) 302 of the memory 202 in FIG. 3 described later.

The channel apparatus 203 generates the CRC data based on data stored on the memory 202. One of the reasons of this is that, apart from that the access to the memory 202 may be performed at a high speed compared with the IO apparatus 30, when there is a defect in the conversion function of channel apparatus, there is a possibility that it is impossible to access the appropriate place of the memory 202.

FIG. 3 is a diagram illustrating the configuration of control data stored in the memory 202 used by an SSCH order in the present embodiment.

The SSCH order 200 is an order to instruct data forwarding using control data, ORB (Operation Request Block) 301, CCW 302, and SSW (Subchannel Status Word) 303 stored in each area of the memory 202. The ORB 301 is control data used for the control of the start function of the channel apparatus 203. The CCW 302 is control data used for specifying detail contents of data forwarding. The SSW 303 enables checking of the status of the channel apparatus 203.

In the ORB 301, CRC Check bit 301a, and CPA (Channel Program Address) 301b are stored. The CRC Check bit 301a is an order for making the channel apparatus 203 selectively perform either of the execution of the SSCH order 200 to perform data forwarding, and the execution of the SSCH order 200 not to perform data forwarding. For example, when the value of the CRC Check bit 301a is 0, the execution of data forwarding is instructed, and when it is 1, the generation of CRC data and the execution of the comparison of CRC data are instructed without executing data forwarding. The CPA 301b is a pointer indicating the storage location of the CCW 302 to be referred to.

In the CCW 302, a data length (Byte Count) 302a, a logical address (Logical Data Address) 302b, a target data length (CRC Byte Count) 302c and CRC data 302d are stored. The data length 302a is the byte count of data specified for data forwarding. The target data length 302c is the byte count of data that has actually been forwarded. The target data length 302c is stored by the channel apparatus 203 that executed the SSCH order 200 together with the CRC data 302d. The logical address 302b specifies the location on the IO apparatus 30 to read out or write in data. Hereinafter, for the sake of convenience, the channel apparatus 203 that executes the SSCH order 200 to instruct data forwarding is described as a first channel apparatus 203a, and the channel apparatus that executes the SSCH order 200 to instruct the generation of CRC data and the comparison of CRC data without performing data forwarding is described as a second channel apparatus 203b.

In the SSW 303, a CCC (channel Control Check) 303a and a CRC check bit 303b are stored. The CCC 303a is used for, apart from the report of the occurrence of an error, the report of whether or not CRC data match. For this reason, CCC 303a has a possibility to be updated by all the channel apparatuses that execute the SSCH order 200. The CRC Check bit 303b is CRC data copied from the ORB 301, and is excluded from the update target by the channel apparatus 203.

In this embodiment, the channel apparatus 203 executes the SSCH order 200 in the configuration as described above according to the value of the CRC Check bit 301a of the ORB 301. Accordingly, the channel apparatus 203 is made to execute the SSCH order 200 that instructs data forwarding, or the channel apparatus 203 is made to execute the SSCH order that instructs the generation of CRC data and the comparison of CRC data, without being made to execute data forwarding.

The data configuration in FIG. 3 extracts and presents data required for explaining the present embodiment, and does not present the entire data configuration of the ORB 301, the CCW 302 and the SSW 303. For example, when performing data forwarding, information to specify the storage apparatus in which data to be forwarded is stored is required. This information is not present in FIG. 3. This information is stored in the CCW 302 for example.

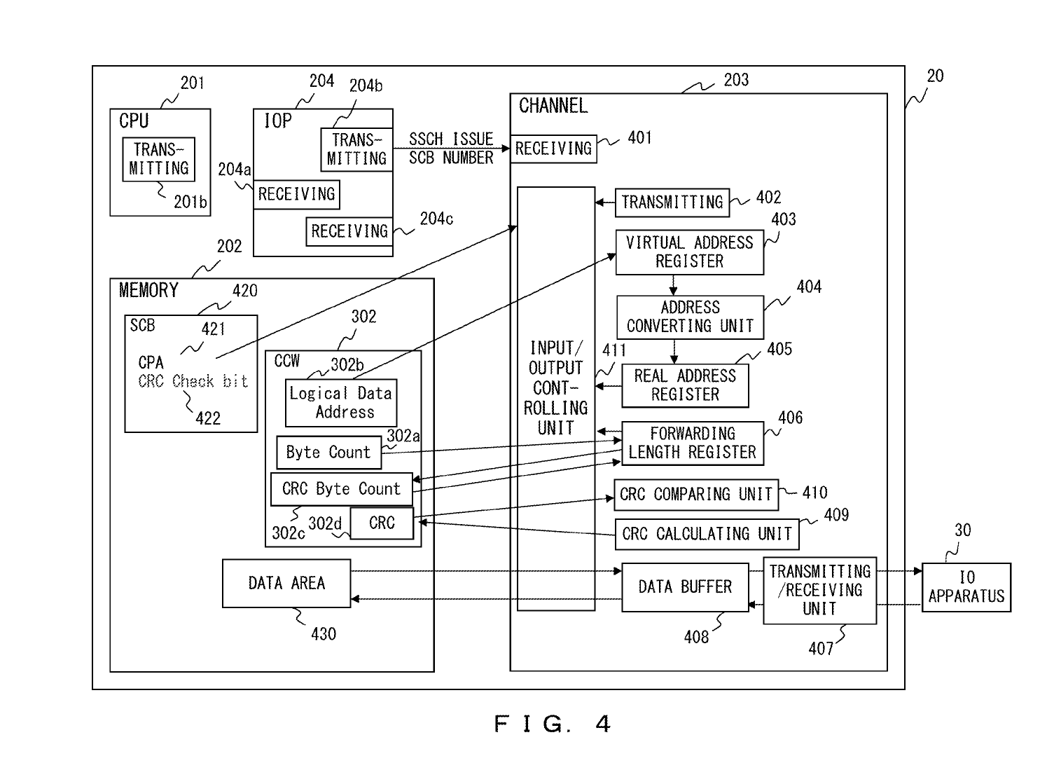

In addition, the execution of the SSCH order requires an SCB (Sub Channel Block) 420 illustrated in FIG. 4. This SCB 420 is control data used for the control of the channel apparatus 203, which is stored in an area secured on the memory 202. The CPU 201 executes the SSCH order 200 using the SCB number that specifies the SCB 420 stored in a GR (General Register) 201a. When the CPU 201 executes the SSCH order 200, the SCB number stored in the GR 201a is stored in a transmission register 201b for transmission to the IOP 204, and the SCB number stored in the transmission register 201b is transmitted to the IOP 204. Details of the IOP 204 are described later. When executing the SSCH order 200, the CPU 201 refers to the ORB 301, and copies the CRC Check bit 301a, and the CPA 301b into the SCB 420. For this reason, when the channel apparatus 203 executes the SSCH order 200, the CRC Check bit 301a copied from the ORB 301 exists in the SCB 420 as a CRC Check bit 421. In addition, the CPA 301b exists in the SCB 410 as the CRC Check bit 421 and a CPA 422.

FIG. 4 is a diagram illustrating the configuration of the channel apparatus 203 according to the present embodiment. Next, the configuration of the channel apparatus 203 that executes the SSCH order 200 as described above is explained specifically with reference to FIG. 4.

The channel apparatus 203 includes, as illustrated in FIG. 4, a reception register 401, a transmission register 402, a virtual address register 403, an address converting unit 404, a real address register 405, a forwarding length register 406, a transmitting/receiving unit 407, a data buffer 408, a CRC calculating unit 409, a CRC comparing unit 410 and an input/output controlling unit 411.

The SCB number stored in the GR 201a of the CPU 201 is transmitted to the IOP 204 via the transmission register 201b, and is stored in the reception register 204a. By this transmission of the SCB number to the IOP 204, the processing of the SSCH order 200 on the CPU 201 side is completed. The SCB number stored in the reception register 204a is transmitted to the channel apparatus 203 via the transmission register 204b. The reception register 401 is for receiving the SCB number transmitted from the IOP 204. The transmission register 402 is for storing the message reporting the execution completion of the SSCH order 200. The message stored in the transmission register 402 is transmitted to the IOP 204 via the inputting/outputting unit 411, and is stored in the reception register 204c. The IOP 204 instructs the interruption mechanism 205 to interrupt to the CPU 201 after the message is stored in the reception register 204c, to make the execution completion of the SSCH order 200 by the channel apparatus 203 reported to the CPU 201. This reporting is performed by rewriting the value of a corresponding register (not illustrated in the drawing) for interruption reporting that is provided in the CPU 201, for example.

The input/output controlling unit 411 above performs input/output of data with other constituent elements within the cluster 20, that is, the memory 202 and the IOP 204, and controls the entirety of the channel apparatus 203. The access to the area in which data to be the target of data forwarding on the memory 202 is stored is performed by the input/output controlling unit 411 referring to the real address register 405 and a carrying length register 406. In addition, the operation frequency of the channel apparatus 203 is evaluated, and the evaluation result is stored in the memory 202. In the present embodiment, as the operation frequency (busy rate), the operating time per second is calculated. The information representing the operation frequency may also be other than the operating time per second.

In the virtual address register 403, by the input/output controlling unit 411, the logical address 302b stored in the CCW 302 is written. The address converting unit 404 converts the logical address 302 into a real address, and writes the converted real address into the real address register 405. In the first channel apparatus 203a, the data length 302a of the CCW 302 is written into the carrying length register 406. In the stage of performing data forwarding with the IO apparatus 30, the carrying length register 406 is used for counting the number of bytes of data that have actually been forwarded. For this reason, the first channel apparatus 203a writes in the value of the carrying length register 406 as the target data length 302c of the CCW 302. In the second channel apparatus 203b, the target data length 302c is written in the carrying length register 406 from the beginning.

The transmitting/receiving unit 407 performs data forwarding with the IO apparatus 30. This data forwarding is performed referring to the virtual address register 403. This data forwarding is performed only in the first channel apparatus 203a.

The data buffer 408 is used for the storage of data for which data forwarding is performed with the IO apparatus 30, or data used for the generation of CRC data. The CRC calculating unit 409 generates CRC data using data stored in the data buffer 308. In the first channel apparatus 203a, CRC data generated by the CRC calculating unit 409 based on data stored in the data buffer 308 is written as the CRC data 302d of the CCW 302. When forwarding data to the IO apparatus 30, the CRC data 302d is transmitted to the IO apparatus 30 together with data stored in the data buffer 308. The data area 430 is an area to write data into the memory 202 by data forwarding, or an area to read out data from the memory 202.

When the channel apparatus is the second channel apparatus 203b, the CRC comparing unit 410 compares the CRC data generated by the CRC calculating unit 409 with the CRC data 302d of the CCW 302. According to the comparison result, the value of the CCC 303a of the SSW 303 is updated. That is, when the comparison result is a mismatch, the value of the CCC 302a is rewritten as 1, and when the comparison result is a match, the value of the CCC 302a remains 0 without rewriting. When the CRC data generated by the CRC calculating unit 409 does not match the CRC data 302d of the CCW 302 due to occurrence of a certain error in the channel apparatus 203, the value of the CCC 302a is set as 1. When the channel apparatus operates as the first channel apparatus 203a that receives data from the IO apparatus 30, the CRC comparing unit 310 compares CRC data received from the IO apparatus 30 with CRC data generated by the CRC calculating unit 409. When the channel apparatus operates as the first channel apparatus 203a that transmits data to the IO apparatus 30, since there is no need to compare CRC date, the CRC calculating unit 410 does not function.

The CCC 302a is stored as a part of a message in the transmission register 402. Accordingly, the writing of the CCC 302a of the CCW 302 is performed by the IOP 204.

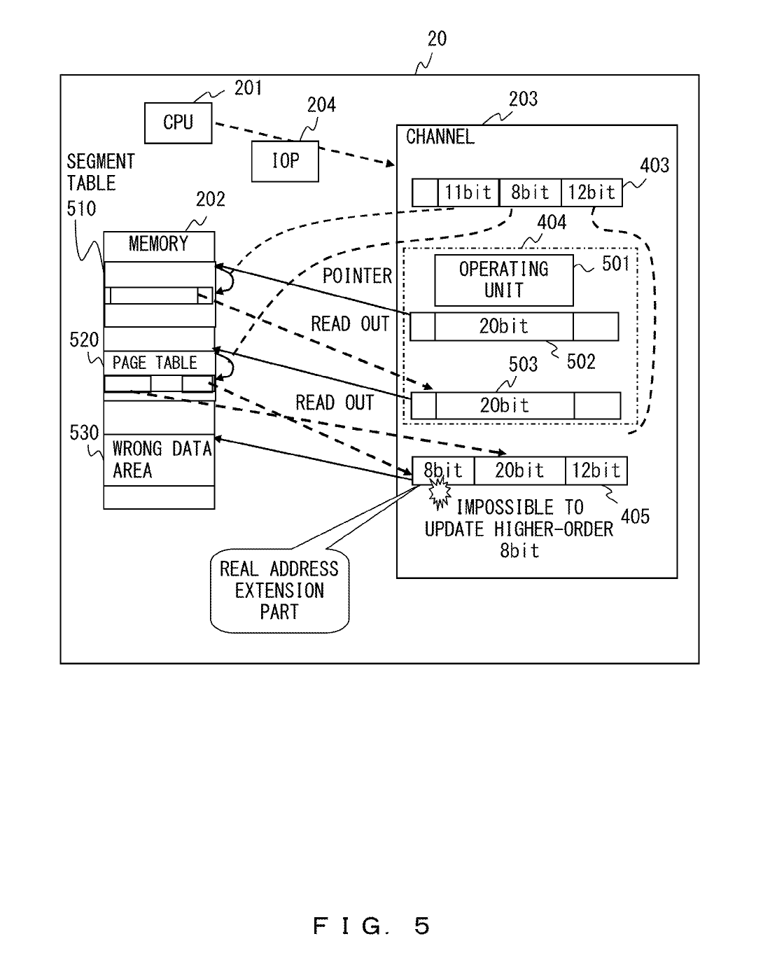

FIG. 5 is a diagram illustrating the configuration, and the operation of the address converting unit. The address converting unit includes, as illustrated in FIG. 5, an operating unit 501, a segment table register 502, a segment entry register 503.

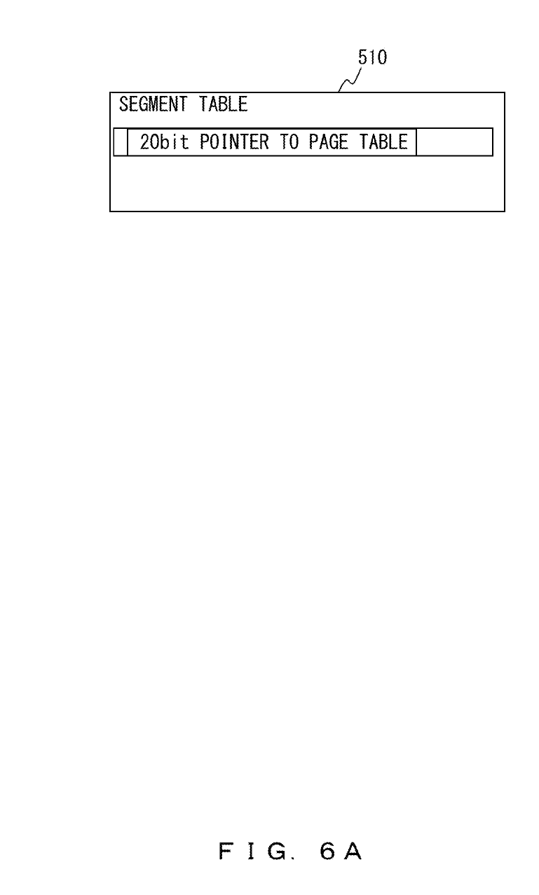

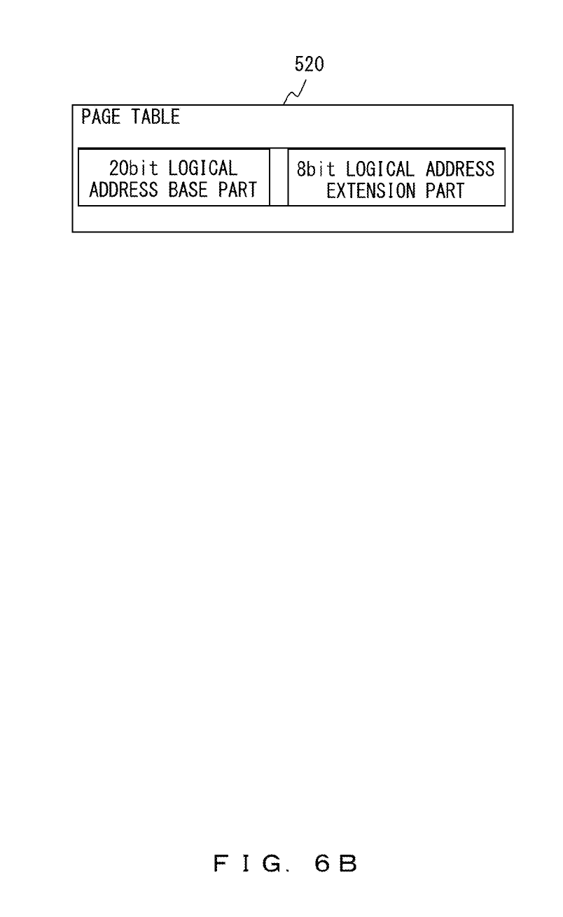

As illustrated in FIG. 5, a segment table 510 and a page table 520 are stored on the memory 202. The segment and the page are both an object of virtual data, and the segment is a unit that covers a larger range than the page. In the segment table 510 and the page table 520, data for obtaining the real address from the logical address is stored in each entry. More specifically, as illustrated in FIG. 6A, the entry of the segment table 510 stores a pointer indicating the storage location (for example the start address) of the corresponding page table 520. The entry of the page table 520 stores a 20-bit logical address base part and an 8-bit logical address extension part.

The logical address 302b stored in the logical address register 403 includes, from the higher-order side, a 11-bit partial address that specifies an entry in the segment table 510, an 8-bit partial address that specifies an entry in the page table 520, and a 12-bit partial address that is used as the real address. The segment table register 502 stores a pointer indicating the storage location (for example the start address) of the segment table 510.

The operating unit 501 refers to the segment table register 502, and the 11-bit partial address of the virtual address register, reads out data for 1 entry of the segment table 510, and stores it in the segment entry register 503. Next, referring to the partial address (pointer) of the segment entry register 503, and the 8-bit partial address of the virtual address register, data for 1 entry of the page table 520, that is, the logical address base part and the logical address extension part are read out. The logical address extension part read out is stored in the real address register 405 as the higher-order 8-bit partial address, and the logical address base part is stored as a lower-order 20-bit partial address following the higher-order 8 bits. As a lower-order address of the logical address base part, the lower-order 12-bit partial address of the logical address is stored. In that way, the operating unit 501 writes the real address corresponding to the logical address stored in the logical address register 403 into the real address register 405.

In the present embodiment, the 8-bit logical address base part is a fixed value. Accordingly, the input/output controlling unit 411 regards it as occurrence of an error when comparing the higher-order 8-bit value of the real address register 405 with the fixed value of the logical address base part, and the higher-order 8 bit value of the real address register 405 and the fixed value of the logical address base part are different.

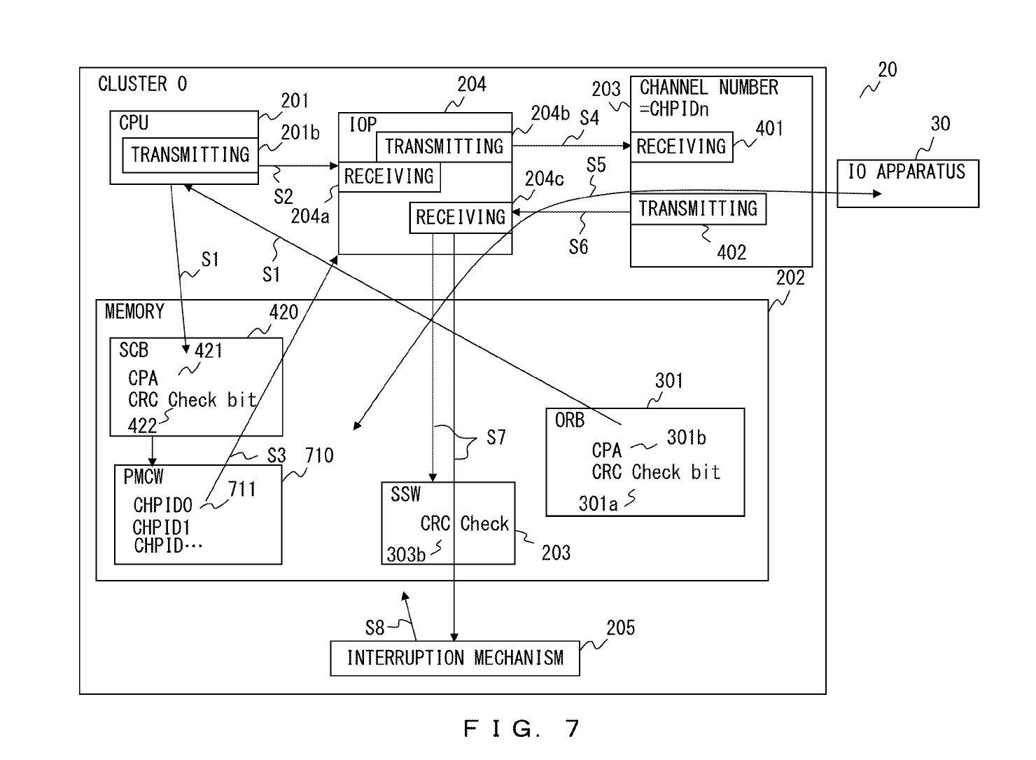

FIG. 7 is a diagram presenting a sequence in which data forwarding by an SSCH order is performed. Here, referring to FIG. 7, the sequence of data forwarding is explained in detail.

When executing the SSCH order 200, the CPU 201 refers to the ORB 301, and together with writing in the CRC Check bit 301a stored in the ORB 301 as the CRC Check bit 421 of the SCB 420, writes in the CPA 301b stored in the ORB 301 as the CPA 422 of the SCB 420 (sequence S1). Next, the CPU 201 stores the SCB number of the SCB 420 in which the CRC Check bit 421 and the CPA 422 have been written in the GR 201a, writes the SCb number stored in the GR 201a into the transmission register 201b, and transmits it to the IOP 204 (sequence S2). By this transmission, the processing of the SSCH order 200 by the CPU 201 is completed.

Upon receiving the SCB number from the CPU 201, the IOP 204 refers to a PMCW (Path Management Control Word) 710, and selects a CHPID (Channel Path Identification), that is, the channel apparatus to operate as the first channel apparatus (sequence S3). Hereinafter, the selected channel apparatus is referred to as the “first channel apparatus 203a”. The PMCW 710 is for managing the channel apparatus that is made to process the SSCH order 200. Each of the channel apparatuses that are capable of processing the SSCH order 200 stores a channel path ID assigned as identification information. In FIG. 7, “CHPID0”, “CHPID1” and the like respectively represent a different channel path ID.

The IOP 204 that has selected the channel apparatus 203 transmits the SCB number to the channel apparatus 203 selected as the first channel apparatus (sequence S4). The selected first channel apparatus 203a is activated by receiving the SCB number from the IOP 204, and the activated first channel apparatus 203a refers to the CCW 302 and performs data forwarding between the memory 202 and the IO apparatus 30 (sequence S5). After performing this data forwarding, the first channel apparatus 203a transmits a message including the CCC 302a to the IOP 204 via the transmission register 402 and the input/output controlling unit 411 (sequence S6). The IOP 204 stores the received CCC 302a in the SSW 303, and instructs the interruption mechanism 205 to report the completion of the data forwarding (sequence S7). The interruption mechanism 205 outputs an interruption signal to report the completion of the data forwarding to the CPU 201 (sequence S8).

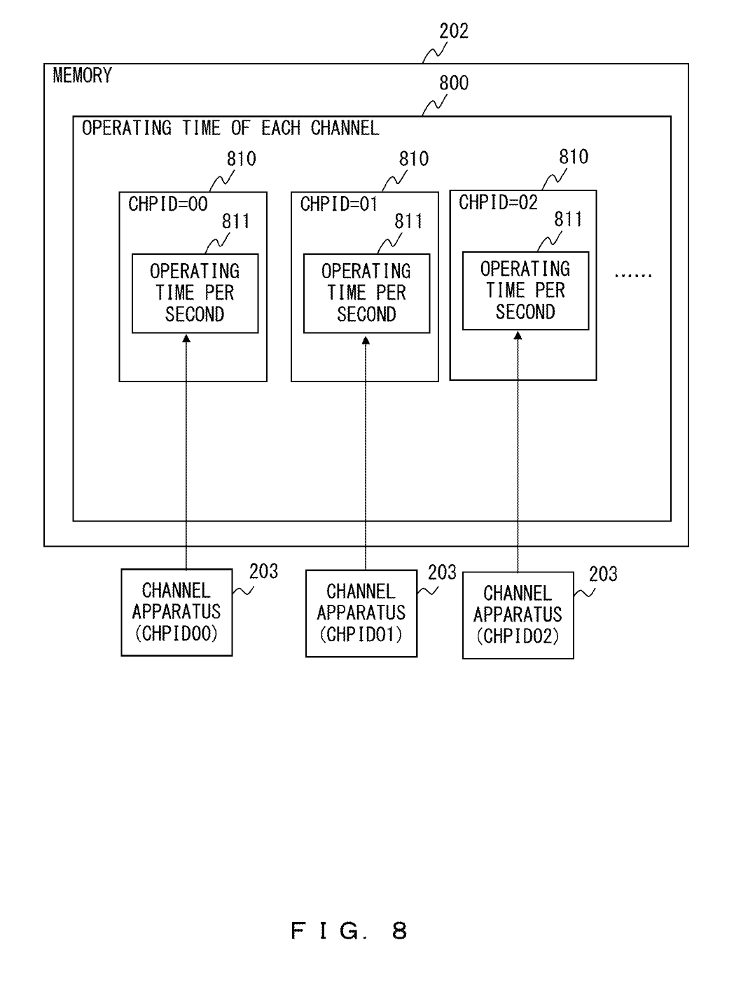

The value of the register for interruption report provided in the CPU 201 is rewritten by the interruption signal. The CPU 201 to which the completion of the data forwarding has been reported by the rewriting of the value of the register for interruption report, next, makes the second channel apparatus 203b perform the generation and comparison of CRC data to check whether or not the data forwarding between the memory 202 and the first channel apparatus 203a was performed appropriately. The selection of the second channel apparatus 203b is performed referring to the busy rate, for example, the operating time of the channel apparatus per second, of the respective channel apparatuses other than the first channel apparatus 203a. In the present embodiment, as illustrated in FIG. 8, an area 800 is secured on the memory 202, and an individual area 810 to store an operating time per second 811 by each channel apparatus 203 is provided in the area 800. Based on this, the CPU 201 selects the channel apparatus with a largest room in the busy rate, that is, the channel apparatus having the smallest operating time per second 811 as the second channel apparatus 203b, by referring to the individual area 810. By selecting the channel apparatus of which busy rate is the lowest as the second channel apparatus 203b, it becomes possible to check the result of the data forwarding by the first channel apparatus 203a in a minimum time. The greater the value of the operating time per second 811 representing the busy rate, the higher frequency of usage of the channel apparatus 203 it represents. The selection of the second channel apparatus may also be performed, for example, considering the presence/absence of the SSCH order 200 being executed, and/or, the number of SSCH order 200 that has been put on wait for execution.

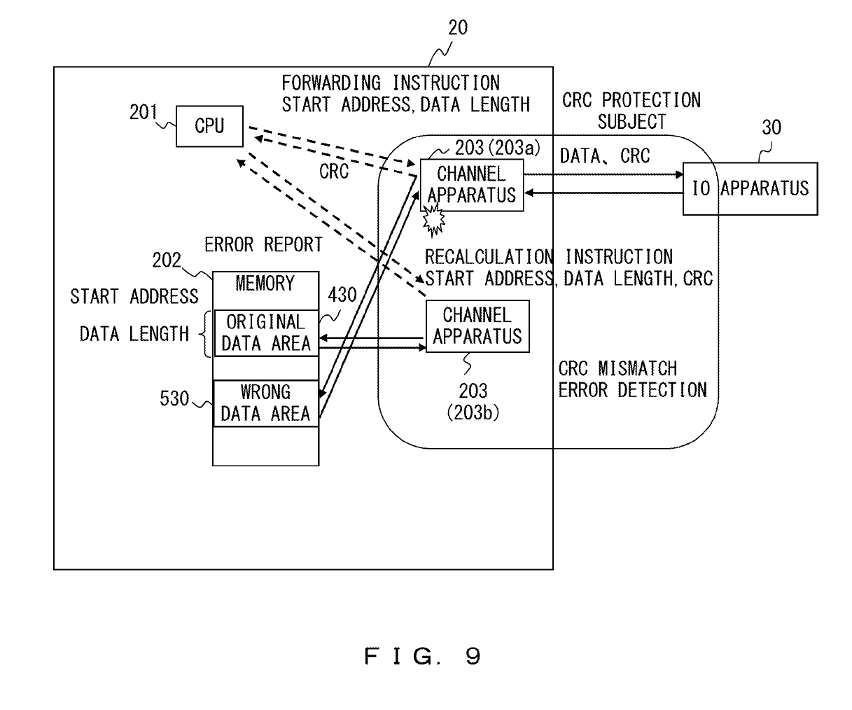

FIG. 9 is a diagram illustrating the range in which data forwarding is monitored according to the present embodiment. As illustrated in FIG. 9, between the channel apparatus 203 and the IO apparatus 30, whether or not data forwarding has been performed appropriately is checked by CRC data attached to data. Between the memory 202 and the channel apparatus 203, for example between two (a plurality of) channel apparatuses, by making the channel apparatus selected as the first channel apparatus execute the SSCH order 200 to actually perform data forwarding, and by making the channel apparatus selected as the second channel apparatus execute SSCH order 200 not to perform data forwarding, whether or not data forwarding has been performed appropriately is checked through CRC data. When one of the two channel apparatuses 203a, 203b accesses a wrong data area 530 other than the original data area 430, the CRC data generated by the respective channel apparatuses are different, and there is a possibility that the actually-performed data forwarding was inappropriate. The comparison of the CRC data generated by the respective channel apparatuses 203a, 203b makes it possible to detect the data forwarding between the memory 202 and the channel apparatus 203 that may have been performed inappropriately.

In the present embodiment, when the CRC data generated respectively by the two channel apparatuses 203a, 203b do not match, a channel apparatus other than the channel apparatuses 203a, 203b (hereinafter, described as the “third channel apparatus 203c”) is further made to perform the generation of CRC data and the comparison of the CRC data. Accordingly, the IOP 204 identifies the one in which a failure has occurred, between the first channel apparatus 203a and the second channel apparatus 203b, using the third channel apparatus 203c. The IOP 204 blocks the one determined as having the occurrence of the failure between the channel apparatuses 203a, 203b, and exclude it from the target of making execute the SSCH order 200.

In the monitoring of data forwarding between the memory 202 and the first channel apparatus 203a using the second channel apparatus 203b, it is difficult to identify which channel apparatus is having the occurrence of a failure (error) even when the CRC data do not match. For this reason, to ensure the execution of appropriate data forwarding, blocking of two channel apparatuses 203 would be possible. However, by using the third channel apparatus 203c in addition to the first channel apparatus 203a and the second channel apparatus 203b, it becomes possible to identify the failed channel apparatus. Accordingly, there is no need to block both the two channel apparatuses 203a, 203b. Based on this, it follows that the channel apparatuses may be used more effectively.

When blocking both the two channel apparatuses 203a, 203b, that is, when it is impossible to identify the failed channel apparatus 203, in order to ensure appropriate data forwarding to be performed between the memory 202 and the IO apparatus 30, data forwarding need to be made again. However, the identification of the failed channel apparatus 203 means that it is possible to identify whether or not data forwarding by the first channel apparatus 203a has been performed appropriately. For this reason, the repeated data forwarding only needs to be performed as required.

Data forwarding between the IO apparatus 30 and the channel apparatus 203 requires a longer time as data being the subject of forwarding is larger. Unnecessary data forwarding between the IO apparatus 30 and the first channel apparatus 203a may be avoided by identifying the failed channel apparatus. By avoiding unnecessary data forwarding, it becomes possible to make the CPU 201 (cluster 20) perform a more efficient data processing. Based on thus, the identification of the failed channel apparatus 203 also has an effect to suppress the increase in the load of the CPU 201 with the monitoring of data forwarding between the memory 202 and the channel apparatus 203.

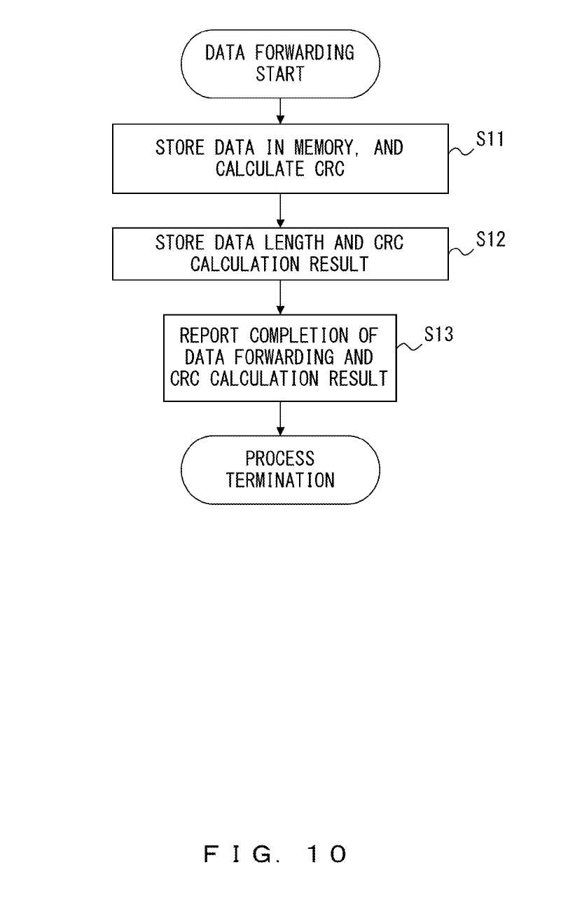

Hereinafter, referring to the flowchart of each process presented in FIG. 10-FIG. 15, the operation of the channel apparatus 203, and the CPU 201 is explained in detail.

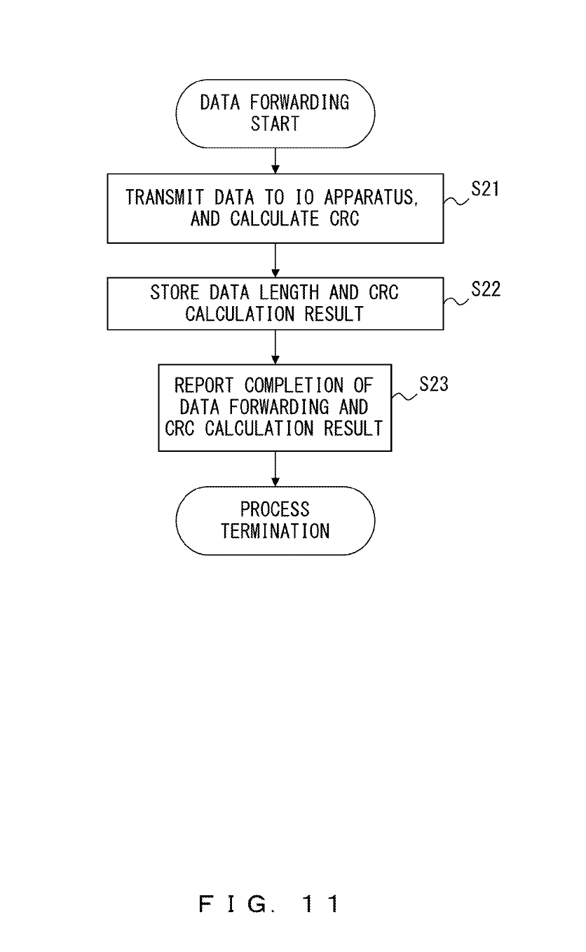

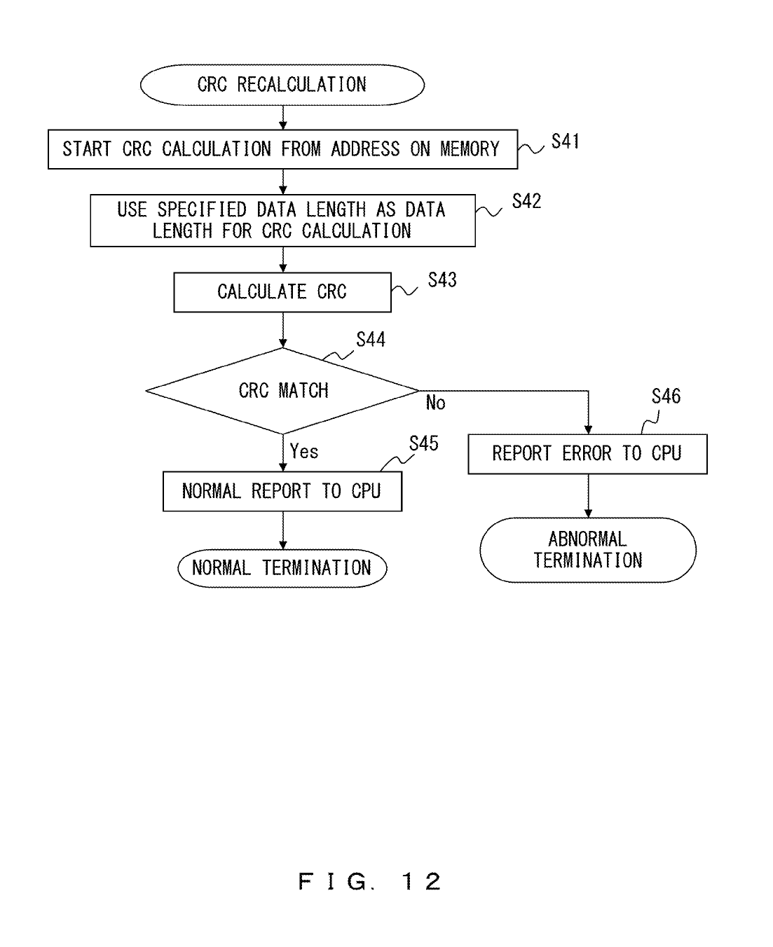

FIG. 10-FIG. 12 is a flowchart of each process executed by the channel apparatus 203. FIG. 10 is a flowchart of the first data forwarding process that realizes data forwarding from the IO apparatus 30 to the memory 202. FIG. 11 is a flowchart of the second data process that realizes data forwarding from the memory 202 to the IO apparatus 30. FIG. 12 is a flowchart of a CRC recalculation process to perform the generation of CRC data and the comparison of CRC data without performing data forwarding between the memory 202 and the IO apparatus 30. All of the respective processes presented in FIG. 10-FIG. 12 are an extraction of a process performed by the channel apparatus 203 by receiving the SCB number from the IOP 204 and representation of its flow. Each process in FIG. 10 and FIG. 11 is executed when the value of the CRC Check bit 301a of the ORB 301 is set to 0. The CRC recalculation process in FIG. 12 is executed when the CRC Check bit 301a of the ORB 301 is set to 1 and the CRC data generated by the CRC calculating unit 409 does not match the CRC data 302d of the CCW 302.

First, referring to FIG. 10, the first data forwarding process is explained in detail.

First, in step S11, the input/output controlling unit 411 stores the logical address 302b of the CCW 302 in the virtual address register 403, and the data length 302a in the carrying length register 406, respectively. The address converting unit 404 converts the logical address 302b into the real address and write it into the real address register 405, and the transmitting/receiving unit 407 transmits the logical address 302b to the IO apparatus 30, and stores data forwarded from the IO apparatus 30 in the data buffer 408. At this time, to check the forwarding of data corresponding to the target data length 302c, the transmitting/receiving unit 407 counts the data length that has actually been forwarded from the IO apparatus 30, using the carrying length register 406 for example. The input/output controlling unit 411 refers to the real address register 405 and the carrying length register 406 and stores the data stored in the data buffer 408 in the memory 202, and the CRC calculating unit 409 calculates CRC data using the data stored in the data buffer 408. The input/output controlling unit 411 performs data forwarding using data stored in the data buffer 408 and the CRC data generated by the CRC calculating unit 409, and after the completion of the data forwarding, moves to step S12.

In step S12, the input/output controlling unit 411 stores the target data length stored in the carrying length register 406 and the CRC data calculated by the CRC calculating unit 409 in the memory 202 as the target data length 302c and the CRC data 302d of the CCW 302. In the next step S13, the input/output controlling unit 411 transmits a message including CCC to the IOP 204. After that, the first data forwarding process is terminated. Here, the CCC transmitted to the IOP 204 only represents whether or not an error has occurred in the channel apparatus 203.

Next, referring to FIG. 11, the second data forwarding process is explained in detail.

First, in step S21, the input/output controlling unit 411 stores the logical address 302b of the CCW 302 in the virtual address register 403, and the data length 302a in the carrying length register 406, respectively. The address converting unit 404 converts the logical address 302b into the real address and writes it into the real address register 405. Then, the input/output controlling unit 411 reads out data of the data area 430 specified by each value of the real address register 405 and the carrying length register 406 and stores it in the data buffer 408. The CRC calculating unit 409 calculates CRC data using the data stored in the data buffer 408. The transmitting/receiving unit 407 refers to the virtual address register 403, and transmits the data stored in the data buffer 408 to the IO apparatus 30 together with the CRC data. At this time, the transmitting/receiving unit 407 counts the target data length using the carrying length register 406. After data forwarding by the transmitting/receiving unit 407 of the data stored in the data buffer 408 and the CRC data generated by the CRC calculating unit 409 to the IO apparatus 30 is completed, shift to step S22 is performed.

In step S22, the input/output controlling unit 411 stores the target data length stored in the carrying length register 406 and the CRC data calculated by the CRC calculating unit 409 as the target data length 302c and the CRC data 302d of the CCW 302. In the next step S23, the input/output controlling unit 411 transmits a message including CCC to the IOP 204. After that, the second data forwarding process is terminated. Here also, the CCC transmitted to the IOP 204 only represents whether or not an error has occurred in the channel apparatus 203

Lastly, referring to FIG. 12, the CRC recalculating process is explained in detail.

First, in step S41, the input/output controlling unit 411 reads out the logical address 302b of the CCW 302 and writes it into the virtual address register 403, and the address converting unit 404 converts the logical address 302b into the real address and writes it into the real address register 405. The input/output controlling unit 411 refers to the real address register 405 and reads out data from the memory 202 and stores it in the data buffer 408, and instructs the CRC calculating unit 409 to start the calculation of CRC data based on the data stored in the data buffer 408.

In step S42, the input/output controlling unit 411 reads out the target data length 302c of the CCW 302 and writes it into the carrying length register 406, and by specifying the size of the data being the target of the generation of the CRC data in the carrying length register 406, limits the data length for which the CRC calculating unit 409 is made to calculate CRC data. In step S43 of the next shift, the input/output controlling unit 411 waits for the CRC calculating unit 409 to calculate the CRC data. After that, shift to step S44 is performed.

In step S44, the input/output controlling unit 411 makes the CRC comparing unit 410 compare the CRC data 302d of the CCW 302 with the CRC data calculated by the CRC calculating unit 409 and receives the comparison result, to judge whether or not the two pieces of CRC data match. When the two pieces of CRC data match, the judgment is Yes, and shift to step S45 is performed. When the two pieces of CRC data do not match, the judgment is No and shift to step S46 is performed.

In step S45, the input/output controlling unit 411 sets 0 as the value of the CCC, and transmits a message including the CCC to the IOP 204. After that, the CRC recalculation process is terminated (normal termination). Meanwhile, in step S46, 1 is set as the value of the CCC, and a message including the CCC is transmitted to the IOP 204. After that, the CRC recalculation process is terminated (abnormal termination).

As described above, the second channel apparatus 203b generates CRC data using data on the memory 202 that has been the subject of data forwarding by the first channel apparatus 302a, that is, the data for which the first channel apparatus 203a has performed data forwarding, or stored by the data forwarding. The result of the comparison of the generated CRC data with the CRC data 302d generated by the first channel apparatus 203a represents, as described above, whether or not the second channel apparatus 203b has generated the CRC data based on the same data on the memory 202 as the first channel apparatus 203a. Therefore, the value 1 of the CCC represents that the two channel apparatus 203 have not generated CRC data based on the same data on the memory 202.

By the detection of an error, the value of the CCC is set to 1. An error occurring in the channel apparatus 203 disables the execution of the appropriate processing. Based on this, in the present embodiment, the CCC is used to report whether or not the CRC data match.

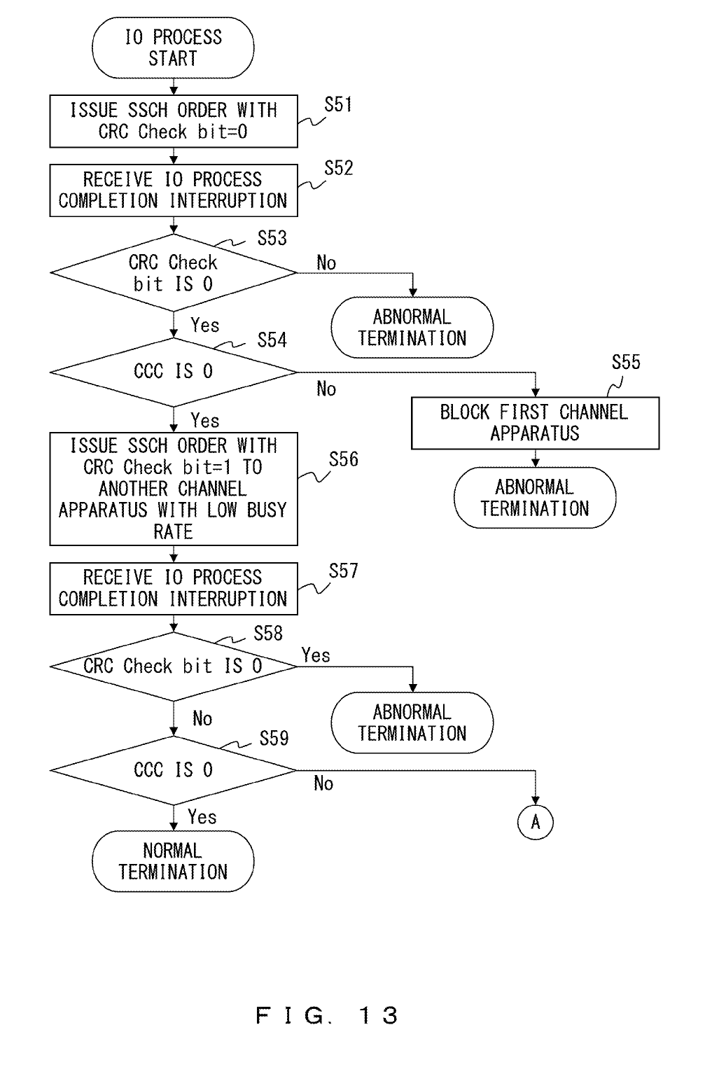

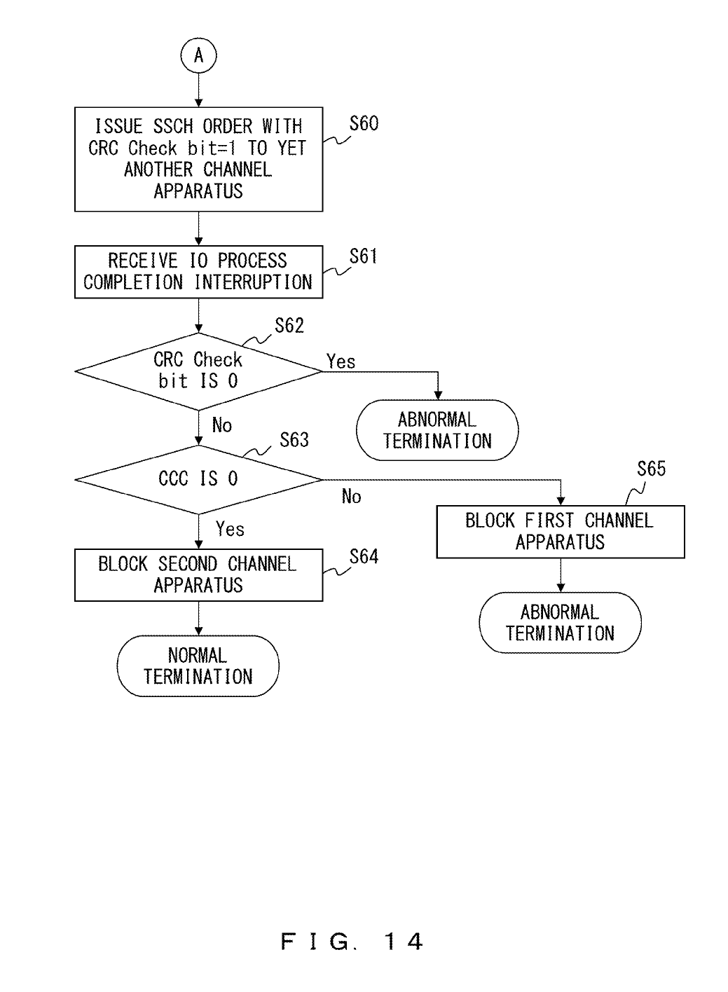

FIG. 13 and FIG. 14 are flowcharts of an IO process executed by the CPU 201. Next, referring to FIG. 13 and FIG. 14, the IO process executed by the CPU 201 is explained in detail. The IO process is an extraction of the process executed by the CPU 201 for data forwarding by the channel apparatus 203 and representation of its flow. The process in FIG. 13 and FIG. 14 is realized by the CPU 201 executing a program stored in the memory 202.

First, in step S51, an SSCH order 200 to set the value of the CRC Check bit to 0 is issued. After the issue of the SSCH order 200, shift to step S52 is performed.

The CRC Check bit of which value is 0 is written into the ORB 301, the SCB 420, and the SSW 303 on the memory 202, respectively. The SCB number of the SCB 420 is transmitted from the CPU 201 to the IOP 204 via the GR 201a and the transmission register 201b, and further transmitted from the IOP 204 to the channel apparatus 203 selected by the IOP 204. The channel apparatus 203 that received the SCB number operates as the first channel apparatus 203a. In step S52, the CPU 201 waits for the interruption to report the completion of data forwarding (the IO process by the channel apparatus 203) to occur by the channel apparatus 203. When the interruption occurs, shift to step S53 is performed.

In step S53, the CPU 201 refers to the SSW 303 on the memory 202, and judges whether or not the value of the

CRC Check bit 303b is 0. When the value of the CRC Check bit 303b is 0, the judgment is Yes, and shift to step S54 is performed. When the value of the CRC Check bit 303b is not 0, that is, when the value of the CRC Check bit 303b has been updated, the judgment is No, and abnormal terminal of the IO process is performed here.

It is impossible for the channel apparatus 203 or the IOP 204 to update the value of the CRC Check bit 303b. The channel apparatus 203 is capable of accessing the memory 202, and the channel apparatus 203 that completed data forwarding writes required data into the memory 202. The value of the CRC Check bit 303b was updated during an extremely short period from when the CPU 201 wrote the value of the

CRC Check bit 303b into the memory 202 until it was read out. Based on this, when the value of the CRC Check bit 303b is not 0, there is a possibility that a certain failure (error) has occurred in the channel apparatus 203 that was operating in that period. The channel apparatus 203 for which the SSCH order 200 is issued is operating in that period. Accordingly, at the time of abnormal termination, the channel apparatus 203 for which the SSCH order 200 is ordered, that is, the first channel apparatus 203a is blocked. In addition, it is assumed that the data forwarding was not performed appropriately, and the CPU 201 makes another channel apparatus 203 perform data forwarding again.

In step S54, the CPU 201 judges whether or not the value of the CCC 303a of the SSW 303 is 0. When the value of the CCC 303a is 0, the judgment is Yes, and shift to step S56 is performed. When the value of the CCC 303a is 1, the judgment is No and shift to step S55 is performed, and the CPU 201 blocks the first channel apparatus 203a. After that, abnormal termination of the IO process is performed. At the time of the abnormal termination, it is also assumed that the data forwarding was not performed appropriately, and the CPU 201 makes another channel apparatus 203 perform data forwarding again.

In step S56, the CPU 201 refers to the area 800 (FIG. 8), and selects the second channel apparatus 203b as the channel apparatus of which busy rate is lowest, and issues the SSCH order of which value of the CRC Check bit is 1. After the issue of the SSCH order 200, shift to step S57 is performed, and the CPU 201 waits for the interruption to report the completion of data forwarding as the IO process by the second channel apparatus 203b to occur. When the interruption to the CPU 201 occurs, shift to step S58 is performed.

In step S58, the CPU 201 refers to the SSW 303 on the memory 202, and judges whether or not the value of the CRC check bit 202b is 0. When the CRC Check bit 303b is 0, that is, when the value of the CRC Check bit 303b has been updated, the judgment is Yes, and abnormal termination of the IO process is performed here. At the time of the abnormal termination, the CPU 201 blocks the second channel apparatus 203b for example. After that, while it is not particularly illustrated in the drawing, execution may start again from step S56. On the other hand, when the CRC Check bit 303b is not 0. The judgment in S58 is No, and shift to step S59 is performed.

In step S59, the CPU 201 judges whether or not the value of the CCC 303a of the SSW 303 is 0. When the CCC 303a is 0, that is, the two pieces of CRC data match, the judgment is Yes, and the IO process is terminated normally here. On the other hand, when the value of the CCC 303a is 1, the judgment is No, and shift to step S60 in FIG. 14 is performed.

In step S60, the CPU 201 refers to the area 800 (FIG. 8), and makes the IOP 204 select the channel apparatus of which busy rate is the second lowest following the channel apparatus selected as the second channel apparatus as the channel apparatus 203c, and issues an SSCH order 200 of which value of the CRC Check bit is 1. After the issue of the SSCH order 200, shift to step S61 is performed, and the CPU 201 waits for the interruption to report the completion of data forwarding as the IO process by the third channel apparatus 203c to occur. When the interruption to the CPU 201 occurs, shift to step S62 is performed.

In step S62, the CPU 201 refers to the SSW 303 on the memory 202, and judges whether or not the value of the CRC Check bit 303b is 0. When the value of the CRC Check bit 303b is 0, that is, the value of the CRC Check bit 303b has been updated, the judgment is Yes, and abnormal termination of the IO process is performed here. At the abnormal termination, the CPU 201 blocks the second channel apparatus 203b as described above for example. After that, while it is not illustrated in the drawing, execution may start again from step S60. On the other hand, when the value of the CRC Check bit 303b is not 0, the judgment is No, and shift to step S63 is performed.

In step S63, the CPU 201 judges whether or not the value of the CCC303a of the SSW 303 is 0. When the value of the CCC 303a is 0, that is, when the CRC data generated respectively by the first channel apparatus 203a and the third channel apparatus 203c match, the judgment is Yes, and the CPU 201 blocks the second channel apparatus 203b instep S64, and after that performs normal termination of the IO process. On the other hand, when the value of the CCC 303a is not 0, the judgment is No, and the CPU 201 blocks the first channel apparatus 203b in step 65, and after that performs normal termination of the IO process.

When the judgment result in step S63 is No, there is a possibility for a case that the first channel apparatus 203a and the second channel apparatus 203b both failed. However, the change of two channel apparatuses 203 failing at the same time is very small. For this reason, in the present embodiment, by using the third channel apparatus 203c, the channel apparatus 203 in which a failure has occurred is identified.

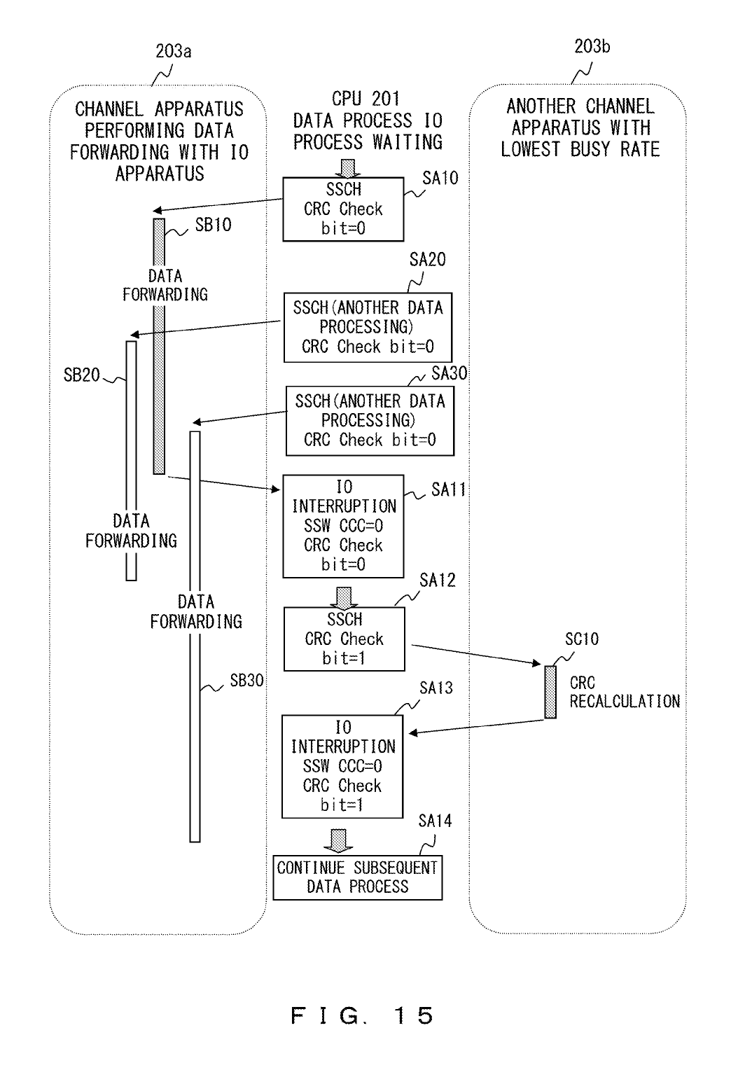

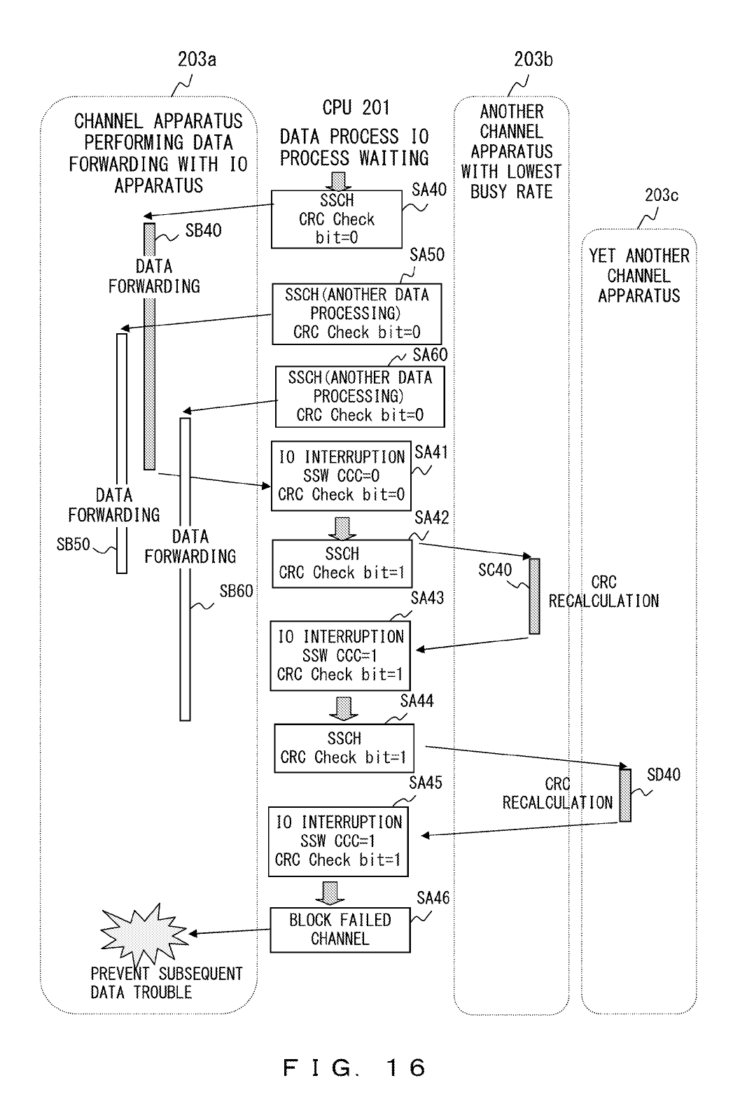

FIG. 15 and FIG. 16 are a sequence diagram presenting the flow of the process performed by each channel apparatus 203 and the CPU 201. FIG. 15 is a sequence diagram of a case when the first channel apparatus 203a and the second channel apparatus 203b are operating normally, and FIG. 16 is a sequence diagram for a case when the first channel apparatus 203a has failed. Next, referring to FIG. 15 and FIG. 16, the operation according the situation of each channel apparatus and the CPU 201 is explained in detail.

First, referring to FIG. 15, the operation for a case in which the first channel apparatus 203a and the second channel apparatus 203b are both operating normally is explained in detail.

The CPU 201 waits for the situation that requires data forwarding by the channel apparatus 203 (described as “DATA PROCESS IO PROCESS WAITING” in the drawing), and issues the SSCH order 200 of which value of the CRC Check bit is 0 (SA10. S51 in FIG. 13). The situation that requires data forwarding is a situation in which the data (page) that the program executed by the CPU 201 requires does not exist on the memory 202. By the issue of the SSCH order 200, the first channel apparatus 203a executes a process for specified data forwarding (SB10. FIG. 10 or FIG. 11), and the completion of the data forwarding process is reported to the CPU 201 by interruption. The CPU 201 that received the report that the data forwarding process had been completed, by referring to the SSW 303, confirms that the value of the CCC 302a is 0, and the value of the CRC Check bit 303b is 0 (SA11. Yes judgment in S54 in FIG. 13).

After issuing the SSCH order 200 to the first channel apparatus 203a, the CPU 201 issues the SSCH order 200 to the first channel apparatus 203a as needed (SA20, SA30. S51 in FIG. 13). Accordingly, the first channel apparatus 203a executes a process for performing data forwarding according to the issued SSCH order 200 (SB20, SB30. FIG. 10 or FIG. 11).

The CPU201 that has confirmed that the value of the CCC 302a is 0 and the CRC Check bit 303b is 0 makes the IOP 204 select the channel apparatus of which busy rate is the lowest as the second channel apparatus 203b, and issues the SSCH order 200 of which value of the CRC Check bit is 1 (SA 12. S56 in FIG. 13). By the issue of the SSCH order 200, the second channel apparatus 203b executes the calculation of CRC data and the comparison of the CRC data using data read out from the memory 202 without performing data forwarding with the IO apparatus 30 (SC10. FIG. 12), and the completion of the processes of the calculation of CRC data and the comparison of the CRC data is reported to the CPU 201 by interruption. The CPU 201 that received the report that the completion of the processes of the calculation of CRC data and the comparison of the CRC data confirms that the value of the CCC 302a is 0 and the value of the CRC Check bit 303b is 1, by referring to the SSW 303 (SA13. Yes judgment in S59 of FIG. 13). When the value of the CCC 302a is 0 and the value of the CRC Check bit 303b is 1, the execution of the subsequent data process (IO process) is continued.

Next, referring to FIG. 16, the operation for a case in which the first channel apparatus 203a has failed is explained in detail.

The CPU 201 waits for the situation that requires data forwarding by the channel apparatus 203 (described as “DATA PROCESS IO PROCESS WAITING” in the drawing), and issues the SSCH order 200 of which value of the CRC Check bit is 0 (SA40. S51 in FIG. 13). By the issue of the SSCH order 200, the first channel apparatus 203a executes a process for specified data forwarding (SB20. FIG. 10 or FIG. 11), and the completion of the data forwarding process is reported to the CPU 201 by interruption. The CPU 201 that received the report that the data forwarding process had been completed, by referring to the SSW 303, confirms that the value of the CCC 302a is 0, and the value of the CRC Check bit 303b is 0 (SA41. Yes judgment in S54 in FIG. 13).

After issuing the SSCH order 200 to the first channel apparatus 203a, the CPU 201 issues the SSCH order 200 to the first channel apparatus 203a as needed (SA50, SA60. S51 in FIG. 13). Accordingly, the first channel apparatus 203a executes a process for performing data forwarding according to the issued SSCH order 200 (SB50, SB60. FIG. 10 or FIG. 11).

The CPU 201 that has confirmed that the value of the CCC 302a is 0 and the CRC Check bit 303b is 0 makes the IOP 204 select the channel apparatus of which busy rate is the lowest as the second channel apparatus 203b, and issues the SSCH order 200 of which value of the CRC Check bit is 1 (SA 42. S56 in FIG. 13). By the issue of the SSCH order 200, the second channel apparatus 203b executes the calculation of CRC data and the comparison of the CRC data using data read out from the memory 202 without performing data forwarding with the IO apparatus 30 (SC40. FIG. 12), and the completion of the processes of the calculation of CRC data and the comparison of the CRC data is reported to the CPU 201 by interruption. The CPU 201 that received the report that the completion of the processes of the calculation of CRC data and the comparison of the CRC data confirms that the value of the CCC 302a is 1 and the value of the CRC Check bit 303b is 1, by referring to the SSW 303 (SA43. No judgment in S59 of FIG. 13).

The CPU 201 that has confirmed that the value of the CCC 302a is 1 and the value of the CRC Check bit 303b is 1 makes the IOP 204 select the channel apparatus of which busy rate is the next lowest as the third channel apparatus 203c, and issues the SSCH order 200 of which value of the CRC Check bit is 1, again (SA44. S60 in FIG. 14). By the reissue of the SSCH order 200, the third channel apparatus 203c executes the processes for the calculation of CRC data and the comparison of the CRC data using data read out from the memory 202 without performing data forwarding with the IO apparatus 30 (SD40. FIG. 12), and the completion of the processes for the calculation of CRC data and the comparison of the CRC data is reported to the CPU 201 by interruption.

The CPU 201 that received the report confirms that the value of the CCC 302a is 1 and the value of the CRC Check bit 303b is 1 by referring to the SSW 303 (SA45, No judgment in S63 in FIG. 14). Accordingly, the CPU 201 executes a blocking process to block the first channel apparatus 203a (SA46. S65 in FIG. 14). Meanwhile, when the CPU 201 confirms that the value of the CCC 302a is 0 and the value of the CRC Check bit 303b is 1, the CPU 201 executes a blocking process to block the second channel apparatus 203a (SA46. S64 in FIG. 14).

Meanwhile, in the present embodiment, the function is added to the SSCH order so that the instruction for the generation of CRC data and the comparison of the CRC data can be performed without performing data forwarding between two storage apparatuses. This is for reducing the change of the control content as much as possible, including the CPU 201 and the IOP 204 and the like. The instruction of the generation of CRC data and the comparison of the CRC data may also be performed by adding a new order, for example. In addition, the transmission/reception method of the required data and order between the channel apparatus 203 and the CPU 201 is not particularly limited to the present embodiment.

While the information processing system and the information processing apparatus according to the present embodiment are realized by using the channel apparatus 203, they may also be realized using a data forwarding apparatus other than the channel apparatus 203. For example, the data forwarding apparatus may be a DMA (Direct Memory Access) controller in which a function to identify the storage location of data to be actually forwarded is implemented. That is, any data forwarding apparatus in which a function to perform a certain calculation process, or operation for data forwarding is implemented will do.

In the information processing system according to the present embodiment, appropriate data forwarding between the main storage apparatus and the inputting/outputting apparatus may be performed with more certainty.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus connected to an inputting/outputting apparatus, the information processing apparatus comprising:
a storage apparatus configured to store data;
a calculation processing apparatus configured to issue an order; and
a data forwarding apparatus configured to
generate, upon receiving a data forwarding order issued by the calculation processing apparatus, based on data stored by the storage apparatus, first error inspection data to detect an error of the data and forward the data and the first error inspection data to the inputting/outputting apparatus,
generate, upon receiving an data inspection order issued by the calculating processing apparatus, based on data stored by the storage apparatus, second error inspection data to detect an error of the data, and
report occurrence of an error to the calculation processing apparatus, when a result of comparison of the first error inspection data generated by another data forwarding apparatus and the second error inspection data is a mismatch.

2. The information processing apparatus according to claim 1, wherein
the information processing apparatus comprises:
a plurality of data forwarding apparatuses; and
a controlling apparatus configured to forward the data inspection order issued by the calculation processing apparatus to the data forwarding apparatus selected from the plurality of data forwarding apparatuses, based on a busy rate being a ratio of a time in which each of the plurality of data forwarding apparatuses performs data forwarding per a unit time.

3. The information processing apparatus according to claim 2, wherein
the data forwarding apparatus further
generates, when the a result of comparison of the first error inspection data by a first data forwarding apparatus in the plurality of data forwarding apparatuses and the second error inspection data by a second data forwarding apparatus in the plurality of data forwarding apparatuses is a mismatch, based on data stored in the storage apparatus, third error inspection data to detect an error of the data, and based on a result of comparison of the first error inspection data and the third error inspection data, and a result of comparison of the second error inspection data and the third error inspection data, judges whether or not any of the plurality of data forwarding apparatus has failed.

4. The information processing apparatus according to claim 1, wherein
in the information processing apparatus,
the storage apparatus further stores a start address of the data in the storage apparatus and a data length of the data; and
the data forwarding apparatus generates the first error inspection data, based on the data, using the start address and the data length, and generates the second error inspection data, based on the data, using the start address and the data length.

5. A control method of an information processing apparatus including a storage apparatus configured to store data and a calculation processing apparatus configured to issue an order, and is connected to an inputting/outputting apparatus, the control method comprising:
issuing, by the calculation processing apparatus, a data forwarding order to a first data forwarding apparatus included in the information processing apparatus;
generating, by the first data forwarding apparatus that received the data forwarding order, based on data stored by the storage apparatus, first error inspection data to detect an error of the data;
forwarding, by the first data forwarding apparatus, the data and the first error inspection data to the inputting/outputting apparatus;
issuing, by the calculation processing apparatus, a data inspection order to a second data forwarding apparatus included in the information processing apparatus;
generating, by the second data forwarding apparatus that received the data inspection order, based on data stored in the storage apparatus, second error inspection data to detect an error of the data;
comparing, by the second data forwarding apparatus, the first error inspection data and the second error inspection data; and
reporting occurrence of an error to the calculation processing apparatus, when a result of comparison by the second data forwarding apparatus is a mismatch.
